(19) United States
(12) Patent Application Publication
(10) Pub. No.: US 2025/0266046 A1
(43) Pub. Date: Aug. 21, 2025

(54) AUDIO PROCESSING DEVICE, AUDIO PROCESSING METHOD, AND COMPUTER PROGRAM PRODUCT

(71) Applicant: Panasonic Automotive Systems Co., Ltd., Kanagawa (JP)

(72) Inventors: Yutaka BANBA, Kanagawa (JP); Tomofumi YAMANASHI, Kanagawa (JP); Naoya MOCHIKI, Kanagawa (JP)

(21) Appl. No.: 18/970,443

(22) Filed: Dec. 5, 2024

(30) Foreign Application Priority Data
Feb. 21, 2024 (JP) 2024-024305

(51) Int. Cl. G10L 17/06; G10L 17/02

(52) U.S. Cl. CPC G10L 17/06; G10L 17/02

(57) ABSTRACT

An audio processing device according to an embodiment includes: a memory in which a program is stored; and a processor configured to perform processing by executing the program. The processing includes: calculating, from registration information in which pieces of audio information of users are registered, group information for each user group in which features of the pieces of audio information are similar between the users; calculating utterance history coefficients for the users based on utterance histories of the users; selecting a predetermined number of users from among the users as recognition targets of the pieces of audio information based on the utterance history coefficients; outputting recognition target person information of the recognition targets; and outputting the recognition target person information and information indicating that users having a same user group are included when the users having the same user group are included in the recognition targets.

### CROSS-REFERENCE TO RELATED APPLICATIONS

This application is based upon and claims the benefit of priority from Japanese Patent Application No. 2024-024305, filed on Feb. 21, 2024, the entire contents of which are incorporated herein by reference.

### FIELD

The present disclosure relates to an audio processing device, an audio processing method, and a computer program product.

### BACKGROUND

Conventionally, there is a processing device that recognizes an uttered command and executes processing. In the case of an in-vehicle device or the like, when there is a fellow passenger other than a user in a vehicle, a word unintentionally uttered by the fellow passenger is recognized as a command. Therefore, the speaker recognition of the audio information is also performed by registering the feature of the voice of the user.

Japanese Patent Application Laid-open No. 2009-86132 discloses a technique for suppressing false recognition of voice recognition caused by a microphone collecting all of utterance of another person, surrounding noise, and the like in addition to utterance of a user.

It is an object of the present disclosure to provide an audio processing device, an audio processing method, and a computer program product, which are capable of reducing false recognition of voice recognition in a case where pieces of audio information of a plurality of registered users are similar to each other.

### SUMMARY

An audio processing device according to an embodiment of the present disclosure includes a memory in which a program is stored and a processor coupled to the memory and configured to perform processing by executing the program. The processing includes: calculating, from registration information in which pieces of audio information of a plurality of users are registered, group information for each user group in which features of the pieces of the audio information are similar between the users; calculating utterance history coefficients for the users based on utterance histories of the users; selecting a predetermined number of users from among the users as recognition targets of the pieces of the audio information based on the utterance history coefficients; outputting recognition target person information of the selected recognition targets; and outputting the recognition target person information and information indicating that a plurality of users having a same user group are included when the plurality of users having the same user group are included in the selected recognition targets.

### BRIEF DESCRIPTION OF THE DRAWINGS

FIG. 1 is a diagram for describing an example of an application target of an audio processing device according to an embodiment;

FIG. 2 is a diagram illustrating an example of a configuration of hardware blocks of the audio processing device according to the embodiment;

FIG. 3 is a diagram illustrating an example of a configuration of functional blocks of the audio processing device according to the embodiment;

FIG. 4 is a diagram illustrating an example of a registration information table generated by a recognition target person selection module;

FIG. 5 is an explanatory diagram of a procedure of selecting a recognition target person;

FIG. 6 is a diagram illustrating an output example of a recognition target person;

FIG. 7 is a diagram illustrating an operation example of manually correcting selection of a recognition target person;

FIG. 8 is an explanatory diagram of Case 2 in which a plurality of members having the same group number are present among the selected recognition target persons;

FIG. 9 is a diagram illustrating an output example of a UI screen and an operation example of a UI screen for correction in Case 2; and

FIG. 10 is a diagram illustrating an example of a recognition target person selection flow.

### DETAILED DESCRIPTION

Hereinafter, embodiments of an audio processing device, an audio processing method, and a computer program product according to the present disclosure will be described in detail with reference to the accompanying drawings.

### Embodiment

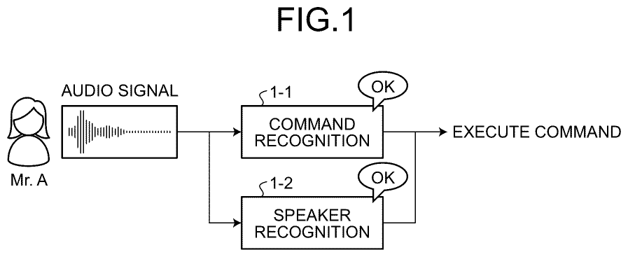

FIG. 1 is a diagram for describing an example of an application target of an audio processing device according to an embodiment. First, a concept of processing of voice recognition will be described. FIG. 1 illustrates a conceptual diagram of processing for performing voice recognition. The processing of voice recognition includes command recognition 1-1 for performing command recognition and speaker recognition 1-2 for performing speaker recognition.

Command recognition 1-1 determines whether an uttered word corresponds to a registered command regardless of who the speaker is, and recognizes the command corresponding to the word.

Speaker recognition 1-2 compares audio information of a speaker who has uttered the word with registered audio information to recognize whether the speaker is a registered speaker. Here, the “registered speaker” is a speaker whose audio information is registered.

Note that a plurality of pieces of audio information may be registered per speaker. For example, in a case where there are a plurality of types of commands, audio information corresponding to each command is registered per speaker, and speaker recognition is performed by audio information corresponding to a command uttered by the speaker.

As indicated by a line of an arrow in FIG. 1, a word uttered by the speaker (Mr. A) is converted into an audio signal via a microphone or the like, for example, and voice recognition is performed on the basis of the audio signal. In voice recognition, when command recognition has succeeded (OK) by command recognition 1-1 and speaker recognition has succeeded (OK) by speaker recognition 1-2, a command for which recognition of command recognition 1-1 has succeeded is output, and the processing device executes the command.

The speaker recognizer 1-2 acquires audio information of the speaker based on the audio signal, and performs speaker recognition by, for example, audio information corresponding to the command recognized in the command recognition 1-1. Note that, in the voice recognition, when the speaker recognition 1-2 is turned off, it is possible to perform switching such that the command can be executed only with the command recognition by the command recognition 1-1.

### Description of Application Target of Audio Processing Device

Voice recognition starts after audio information of a user who uses voice recognition is registered in advance. In a case where there are a plurality of users using voice recognition, audio information of each user is registered. Therefore, the number of registered speakers whose audio information is registered is plural.

Since there are a plurality of registered speakers, in a case where there are a plurality of registered speakers having similar audio information among the registered speakers, the users may erroneously recognize that the actual speakers are mistaken.

In the present embodiment, a configuration of an audio processing device will be described in detail by an example in which the audio processing device is combined with an apparatus that performs speaker recognition using audio information of a plurality of registered speakers. Note that the audio processing device may be used as a single device in combination with another voice recognition device, may be integrated in the voice recognition device in advance, or may be integrated with the voice recognition device in an execution device that executes a command. Hereinafter, an in-vehicle device such as a car navigation system which is an execution device will be described as an example.

### Hardware Configuration of Audio Processing Device

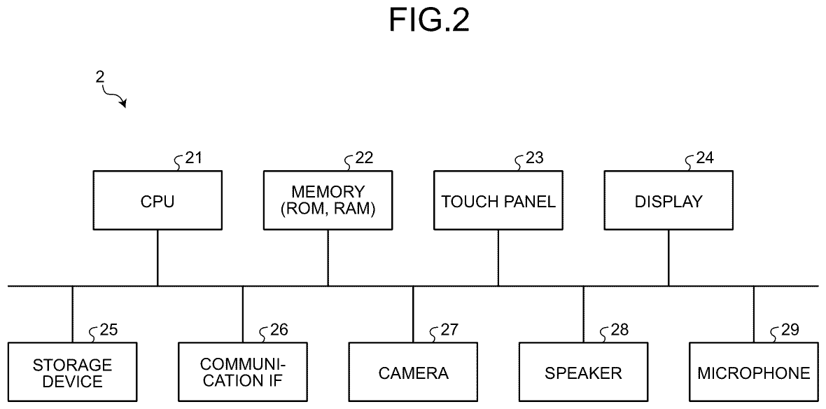

FIG. 2 is a diagram illustrating an example of a configuration of hardware blocks of the audio processing device according to the embodiment. A configuration of an in-vehicle device such as a car navigation is illustrated as an example. Note that the configuration of the in-vehicle device is an example, and is not limited thereto.

The in-vehicle device 2 illustrated in FIG. 2 includes a CPU 21, a memory 22, a touch panel 23, a display 24, a storage device 25, a communication interface (IF) 26, a camera 27, a speaker 28, and a microphone 29. The units are interconnected via a bus.

The CPU 21 is a central processing unit (CPU), and executes a predetermined program stored in the memory 22 to execute control and processing of each unit.

The memory 22 is a read only memory (ROM) or a random access memory (RAM). The memory 22 stores predetermined programs and data. In addition, the CPU 21 has a work area used for processing.

The touch panel 23 is a sensor that detects a touch position on the screen of the display 24.

The display 24 is a display such as a liquid crystal display.

The storage device 25 is a storage such as a hard disk drive (HDD) or a solid state drive (SSD).

The communication IF 26 is a communication interface that communicates with an external device. For example, the communication IF 26 is connected to a predetermined network (such as the Internet) by wireless communication.

The camera 27 includes an imaging device such as a charge coupled device (CCD) or a complementary metal oxide semiconductor (CMOS), and captures an image of an imaging target in the vehicle or the like.

The speaker 28 outputs a predetermined sound (an operation sound, a notification sound, or the like) or a voice (a response message or the like) reproduced by the CPU 21.

The microphone 29 converts a voice into an audio signal and inputs the audio signal.

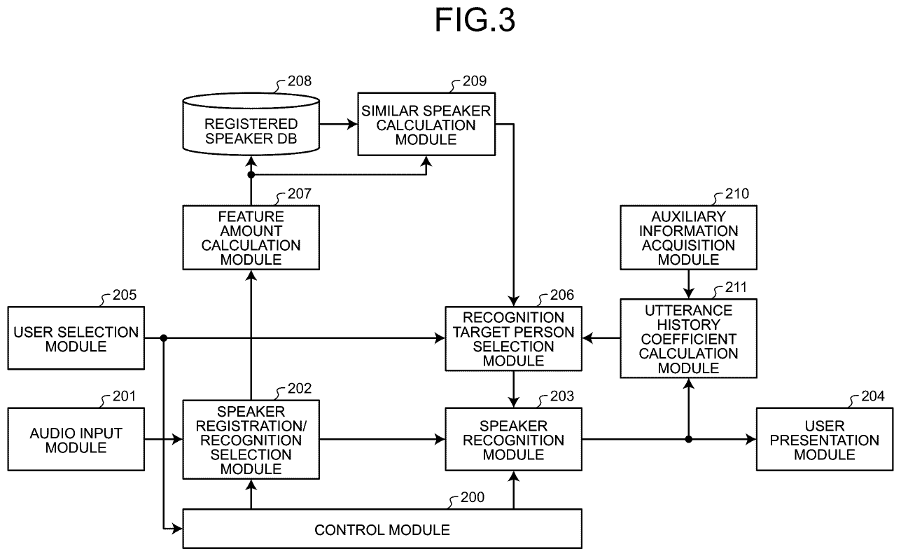

FIG. 3 is a diagram illustrating an example of a configuration of functional blocks of the audio processing device according to the embodiment. Each functional block of the audio processing device is realized by the CPU 21 executing a program in the memory 22 or the like. Here, functions related to sound processing of speaker recognition are illustrated, and other functions are not illustrated.

As illustrated in FIG. 3, a control module 200, an audio input module 201, a speaker registration/recognition selection module 202, a speaker recognition module 203, a user presentation module 204, a user selection module 205, a recognition target person selection module 206, a feature amount calculation module 207, a registered speaker database (registered speaker DB) 208, a similar speaker calculation module 209, an auxiliary information acquisition module 210, and an utterance history coefficient calculation module 211 are realized. Here, the recognition target person selection module 206 corresponds to a “selection module”. The user presentation module 204 corresponds to an “output module”. The feature amount calculation module 207 corresponds to an “audio information calculation module”. The similar speaker calculation module 209 corresponds to a “group information calculation module”.

The control module 200 integrally controls each unit of the functional block according to the operation mode of the audio processing device.

The audio input module 201 receives an audio signal from the microphone 29.

The speaker registration/recognition selection module 202 receives selection of either “speaker registration” or “speaker recognition” from the control module 200.

The speaker recognition module 203 performs predetermined processing related to speaker recognition. The predetermined processing includes speaker recognition based on an audio signal after the start of speaker recognition.

The user presentation module 204 receives the output information from the speaker recognition module 203 and presents the information to the user. For example, the user presentation module 204 displays information on the display 24. The user presentation module 204 may present the information by audio output from the speaker 28. The information to be presented includes information for advance preparation for speaker recognition.

The user selection module 205 receives user selection for the information presented by the user presentation module 204. For example, the user selection module 205 receives a selection operation by the user via the touch panel 23. Not only the touch panel 23 but also an input means such as an input key may be used. Furthermore, the user selection module 205 may receive a selection operation by voice by the user via command recognition.

In the present embodiment, as an example, a configuration in which information is presented by the display 24 and a selection operation by the user is received via the touch panel 23 will be described as an example. Note that a configuration different from this may be adopted. For example, information may be presented by audio output via the speaker 28, and the user may select the information by voice via the microphone 29.

The recognition target person selection module 206 selects a predetermined number of registered speakers as recognition target persons in the order of utterance history coefficients that are coefficients based on an utterance history of each registered speaker from a list of registered speakers (users) whose audio information is registered.

Furthermore, in a case where there is a possibility of being erroneously recognized by speaker recognition, for example, in a case where registered speakers whose registered audio information is similar to each other are present among the recognition target persons to be selected, the recognition target person selection module 206 excludes similar registered speakers from the recognition target persons by a predetermined method or adds notification information for attracting attention of the user.

When the speaker registration/recognition selection module 202 is selected as “speaker registration”, the feature amount calculation module 207 calculates a speaker feature amount from an audio signal that is a voice of a speaker input from the audio input module 201 through DNN, and registers the speaker feature amount in the registered speaker DB 208. The speaker feature amount is an example of “audio information” and is information indicating a voice feature of the speaker.

The registered speaker DB 208 stores data of a plurality of registered speakers in association with registered speaker identification information that is identification information of the registered speaker and speaker feature data that is audio information of the speaker. The registered speaker identification information is information that can uniquely identify the registered speaker, and is, for example, a name (hereinafter, Mr. A, Mr. B, and the like will be referred to) of the registered speaker. The stored database file corresponds to “registration information”.

The similar speaker calculation module 209 acquires registration information in the registered speaker DB 208 to calculate a similar speaker group. The speaker feature amount may be acquired from the feature amount calculation module 207 for each speaker registration. The similar speaker group is group information of registered speakers whose registered speaker feature amounts are within a similar range. As the similar range, a range in which registered speakers are erroneously recognized when speaker recognition is performed by the speaker recognition module 203 is set. The group information is calculated by the following method as an example.

At the time of registering speakers, a similarity between the speakers is obtained with respect to a feature amount vector (d-vector) of speaker feature amounts calculated based on an audio signal of the speaker. As the similarity, a cosine similarity with which the similarity can be determined from an angle between two vectors is used. The cosine similarity between the feature amount vectors of the two speakers to be compared is calculated for each registered speaker to obtain an inter-speaker similarity. Then, grouping is performed in a case where the inter-speaker similarity is equal to or greater than a specified value that is a similar range. At this time, a clustering method such as a k-means method may be used. The grouped members are managed as group information for each group. This processing is performed every time a new speaker is registered, and the group information is updated.

Note that, in a case where there are a plurality of commands to be registered as speaker feature amounts, a similarity is obtained for each command between speakers with respect to a feature amount vector (d-vector) obtained for each command uttered by the speaker. Furthermore, an average of the similarities obtained for the respective commands among the commands is obtained, and the inter-speaker similarity is obtained. Then, grouping is performed when the inter-speaker similarity is equal to or greater than the specified value.

The auxiliary information acquisition module 210 acquires information on the frequency of utterance of the registered speaker. As an example, the auxiliary information acquisition module 210 acquires registered speaker identification information recognized as a speaker when speaker recognition is successful by the speaker recognition module 203. Further, the auxiliary information acquisition module 210 may acquire, together with the registered speaker identification information, information such as a time and a day of the week when the speaker recognition is successful by the speaker recognition module 203.

The utterance history coefficient calculation module 211 sets an utterance history regarding the registered speaker based on the information acquired by the auxiliary information acquisition module 210, and calculates an utterance history coefficient for each registered speaker based on the set utterance history.

Here, an example of a method of calculating an utterance history coefficient based on an utterance history will be described. For example, when the number of registered speakers is N, the utterance history coefficient (C log (k)) is calculated for each registered speaker (k) using the following Equation 1.

$$C\_log ( k ) = 100 \cdot \frac{sum\_prm ( k )}{{\sum }_{k = 0}^{N} sum\_prm ( k )} \qquad ( Equation 1 )$$

Herein, sum_prm (k)=(A_{frql}·Freq_long_sr(k))+A_{frqs}·Freq_short_sr(k)+A_{wd}·W_day(k)). Further, A_{frql}: weight to Freq_long_sr(k), A_{frqs}: weight to Freq_short_sr(k), A_{wd}: weight to W_day(k), and each weight (A_{frql}, A_{frqs}, A_{wd}) may be a fixed value set by the user or may be variable by the system.

Freq_long_sr(k) is an expression for calculating the utterance ratio of the recognized speaker (k). For example, the utterance ratio is calculated by dividing the number of times of recognition for each speaker by the total number of times of speaker recognition from the speaker history.

Freq_short_sr(k) is an expression for calculating the utterance ratio of the speaker recognized within a shorter period. The number of times of recognition for each speaker may be weighted so as to have a larger value in order of proximity to the current time. This makes it possible to increase the utterance history coefficient of the speaker whose utterance is recognized in a period closer to the current time.

W_day(k) is an expression for calculating an utterance ratio based on the same day of the week, the same time zone, or the like. For each speaker, the utterance ratio is quantified using the utterance history for each day of the week or each time zone according to the degree of separation between the current day of the week or time zone and each reference.

For example, the frequency of use at what time on what day of the week is calculated from the time record included in the utterance history, and the degree of separation of time from the actual use day and time zone is quantified. The value is set to be larger as the degree of separation of the time from the reference is smaller. Therefore, the user who uses the same date, day of the week, or time zone every time has a larger utterance history coefficient when the user uses the same date, day of the week, or time zone, and the selection accuracy of the user who uses the same date, day of the week, or time zone is higher.

Note that, in the case of a navigation system, W_day(k) may be calculated by associating the frequency of setting the same destination in the same time zone on the same day of the week and the audio operation with the utterance history.

Each unit of the functional block illustrated in FIG. 3 performs the following operation according to an operation mode (as an example, a speaker registration mode and a speaker recognition mode) of the audio processing device.

### Speaker Registration Mode

In the audio processing device, when the user selection module 205 receives the operation of speaker registration, the control module 200 switches the selection of the speaker registration/recognition selection module 202 to “speaker registration” and enters the speaker registration mode.

In the speaker registration mode, the speaker registration/recognition selection module 202 inputs an audio signal of the speaker from the audio input module 201 and outputs the audio signal to the feature amount calculation module 207. The feature amount calculation module 207 calculates a speaker feature amount based on the audio signal and outputs the speaker feature amount to the registered speaker DB 208. The registered speaker DB 208 registers the speaker feature amount output from the feature amount calculation module 207 in association with the registered speaker identification information of the speaker. In the case of an unregistered speaker, the registered speaker DB 208 registers the speaker feature amount in association with new registered speaker identification information.

When registering the speaker feature amount in the registered speaker DB 208, the feature amount calculation module 207 notifies the similar speaker calculation module 209 that the speaker feature amount has been registered in the registered speaker DB 208. The similar speaker calculation module 209 detects that the speaker feature amount in the registered speaker DB 208 has been updated by the notification, and acquires registration information in the registered speaker DB 208 to calculate a similar speaker group each time the speaker feature amount is registered.

### Speaker Recognition Mode

In the audio processing device, the control module 200 switches the selection of the speaker registration/recognition selection module 202 to “speaker recognition” to switch to the speaker recognition mode when the normal power supply is activated or after the speaker registration mode is ended.

In the speaker recognition mode, the control module 200 turns off the input of the audio signal to the speaker recognition module 203 until the advance preparation for speaker recognition is ended.

The similar speaker calculation module 209 outputs the latest registration information in the registered speaker DB 208 and information indicating the similar speaker group calculated from the latest registration information to the recognition target person selection module 206.

The utterance history coefficient calculation module 211 updates the utterance history based on the information acquired by the auxiliary information acquisition module 210, and calculates an utterance history coefficient for each registered speaker based on the updated utterance history.

The recognition target person selection module 206 acquires the utterance history coefficient calculated by the utterance history coefficient calculation module 211, and selects a predetermined number of registered speakers as the recognition target persons in the order based on the utterance history coefficient from registered speakers (list) included in the registration information output by the similar speaker calculation module 209. Furthermore, in a case where registered speakers whose registered audio information is similar to each other are present among the recognition target persons to be selected, the recognition target person selection module 206 excludes similar registered speakers from the recognition target persons by a predetermined method or adds notification information for calling attention to the user on the basis of the information of the similar speaker group. The selection of the recognition target person will be described later in detail with reference to the drawings.

The recognition target person selection module 206 outputs the registration information and the notification information of the selected recognition target person to the speaker recognition module 203.

The speaker recognition module 203 outputs confirmation information of the registered speaker who has become the recognition target person to the user presentation module 204 based on the registration information and the notification information of the recognition target person output from the recognition target person selection module 206.

Thereafter, when receiving a predetermined operation from the user selection module 205, the recognition target person selection module 206 outputs output information corresponding to the predetermined operation to the speaker recognition module 203.

For example, when receiving an operation of deleting a predetermined registered speaker from among registered speakers selected as recognition target persons, the recognition target person selection module 206 deletes the registered speaker from the recognition targets, and outputs, to the speaker recognition module 203, registration information obtained by adding the number of the registered speakers deleted to the recognition targets in the order based on the utterance history coefficient. The output information of the user presentation module 204 is updated on the basis of the output information.

Furthermore, when receiving an operation of adding a registered speaker by selection later from among the registered speakers selected as the recognition target persons, the recognition target person selection module 206 adds the registered speaker to be added to the number of the deleted registered speakers.

Note that the selection of the registered speaker to be added can be performed by the recognition target person selection module 206 outputting a list of registered speakers included in the entire registration information before the selection of the recognition target to the speaker recognition module 203, and the speaker recognition module 203 outputting a list of registered speakers to the user presentation module 204. For example, the recognition target person selection module 206 may receive an operation of displaying a list of registered speakers included in the registration information from the user selection module 205, and output the list of registered speakers to the speaker recognition module 203.

When the advance preparation is ended, the control module 200 turns on the input of the audio signal to the speaker recognition module 203. The speaker recognition module 203 calculates the speaker feature amount based on the input audio signal, compares the calculated speaker feature amount with the speaker feature amount of each registered speaker of the recognition target determined in advance preparation, and recognizes the registered speaker whose similarity to the speaker feature amount of the input audio signal exceeds a threshold as the speaker.

The in-vehicle device 2 executes a command of an audio signal of the speaker recognized by the command recognition 1-1 based on a result of the speaker recognition by the speaker recognition module 203 (speaker recognition 1-2).

Description of recognition target person selection by recognition target person selection module 206

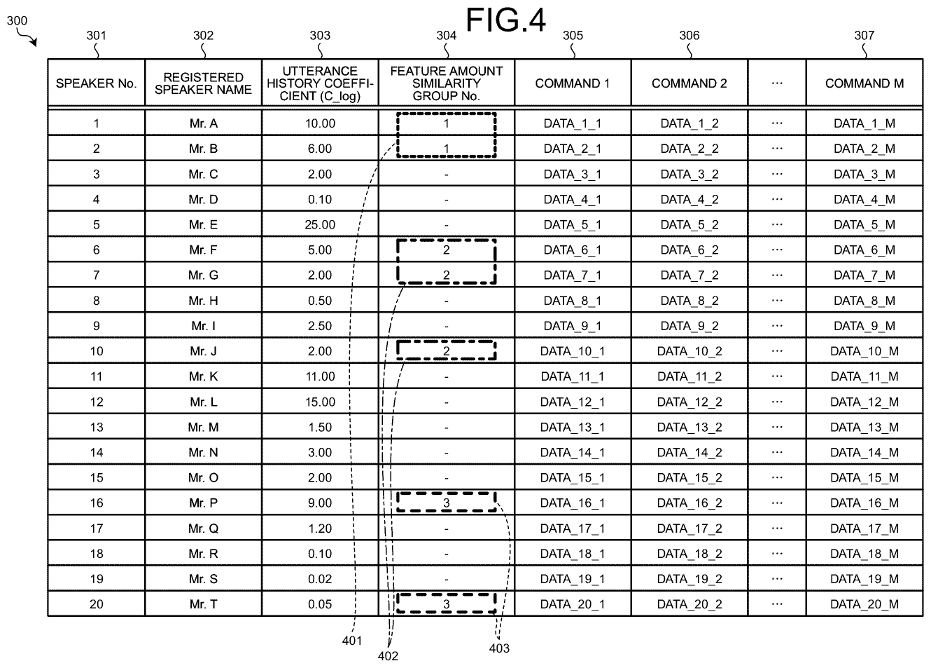

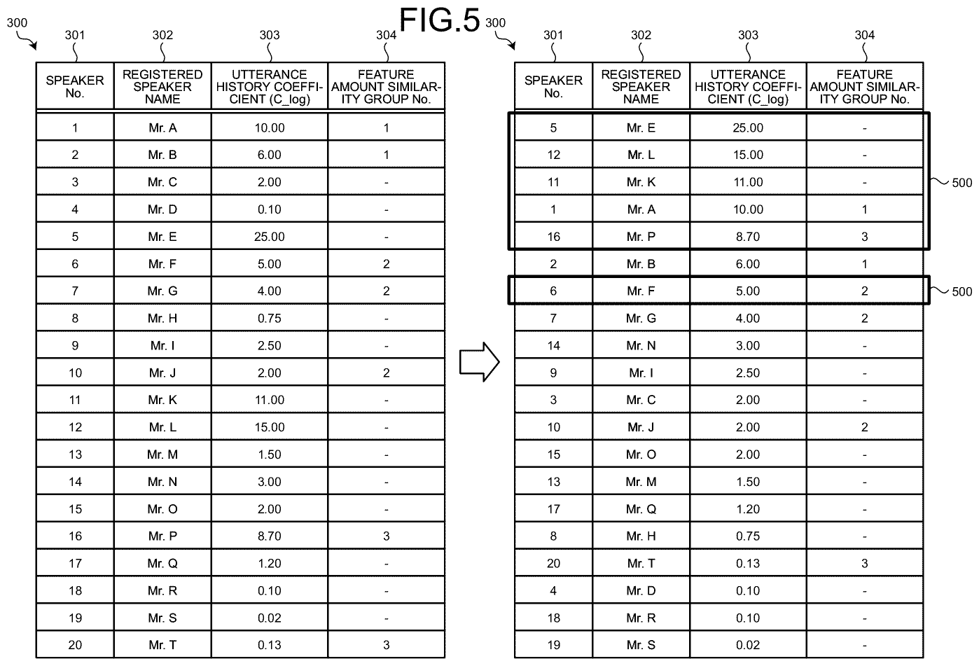

Next, the recognition target person selection by the recognition target person selection module 206 will be described in detail with reference to FIGS. 4 and 5. FIG. 4 is a diagram illustrating an example of the registration information table generated by the recognition target person selection module 206. A registration information table 300 illustrated in FIG. 4 is obtained by adding a similar speaker group field and an utterance history coefficient field to the acquired registration information. FIG. 4 illustrates a list of information on the registered 20 speakers. Note that the number of registered speakers is an example, and the present invention is not limited thereto.

The registration information table 300 illustrated in FIG. 4 is a table provided with a “speaker No.” field 301, a “registered speaker name” field 302, an “utterance history coefficient” field 303, a “feature amount similarity group No.” field 304, a “command 1” field 305, a “command 2” field 306, . . . , and a “command M” field 307.

A serial number is set in the “speaker No.” field 301. In the “registered speaker name” field 302, the name of the registered speaker is set in association with the number in the “speaker No.” field 301. Here, the name of the registered speaker is an example of registered speaker identification information. When the user is presented, this name is presented.

An utterance history coefficient of each registered speaker is set in the “utterance history coefficient” field 303. Each utterance history coefficient is a value calculated by the utterance history coefficient calculation module 211. It can be estimated that the registered speaker having a higher value of the utterance history coefficient is a user who uses the speaker recognition more frequently, that is, a user who is highly likely to use the speaker recognition also this time. On the contrary, a registered speaker whose value of the utterance history coefficient is low, in particular, a registered speaker whose value falls below a predetermined value can be estimated to be a user who is highly likely not to use the speaker recognition also this time.

In the “feature amount similarity group No.” field 304, a group number for distinguishing each feature amount similarity group is set. The same group number is set to registered speakers of the same group based on information calculated by the similar speaker calculation module 209 as registered speakers of the same group. In the example illustrated in FIG. 4, Mr. A and Mr. B are in the same group 401, and a group number 1 is set. Mr. F, Mr. G, and Mr. J are in the same group 402, and a group number 2 is set. Mr. P and Mr. T are in the same group 403, and a group number 3 is set.

Each piece of data in the “command 1” field 305, the “command 2” field 306, . . . , and the “command M” field 307 is data of audio information (speaker feature amount) of each registered speaker corresponding to a plurality of registered commands (Command 1, Command 2, . . . . Command M) registered.

FIG. 5 is an explanatory diagram of a procedure of selecting a recognition target person. The command field in the registration information table 300 is not illustrated because it is an explanatory diagram.

FIG. 5 illustrates arrangement of data before and after sorting the registration information table 300 by the values in the “utterance history coefficient” field 303. As indicated by the arrow, the data is arranged on the right side after sorting.

After the sorting, as illustrated in FIG. 5, the values in the “utterance history coefficient” field 303 are arranged in descending order.

The recognition target persons are selected in descending order of the values in the “utterance history coefficient” field 303. The number of recognition target persons may be arbitrarily determined by the user, or may be automatically set according to a situation to be used. For example, in the case of use in a vehicle, since the maximum number of passengers is determined depending on the vehicle type, the number of recognition target persons may also be automatically set accordingly. The number of recognition target persons may be manually set by the user or may be automatically set. Alternatively, the user may manually reset the automatically set number.

In the case of automatic setting, for example, since a vehicle includes a seat belt wearing sensor or a seat sensor, the number of passengers can be detected by combining the sensor outputs of the seat belt wearing sensor or the seat sensor, and the detected number of passengers can be automatically set as the number of recognition target persons.

In this example, the condition of the number of recognition target persons is “6”. Furthermore, a condition “15” of a lower limit value of the utterance history coefficient is provided. First, when the values in the “utterance history coefficient” field 303 are selected in descending order, six persons, namely, Mr. E, Mr. L, Mr. K, Mr. A, Mr. P, and Mr. B, are determined. However, Mr. A and Mr. B among these six members are members having the same group number in the “feature amount similarity group No.” field 304. In this case, since there is a high possibility of erroneous recognition when speaker recognition is performed, members having the same group number are excluded as much as possible using the condition of excluding members lower than the lower limit value “15” of the utterance history coefficient.

Comparing the “utterance history coefficient” fields 303 of Mr. A and Mr. B, the value of Mr. A is high, so Mr. A remains. For Mr. B, the value of Mr. B is compared with the lower limit value “15”, and it is estimated that there is a high possibility that the speaker recognition is not used also this time because the value of Mr. B is below the lower limit value “15”, and Mr. B is deleted. Since Mr. B has been deleted, Mr. F having the next highest value of the “utterance history coefficient” field 303 is selected. By this method, six persons in the selection frame 500 become recognition target persons.

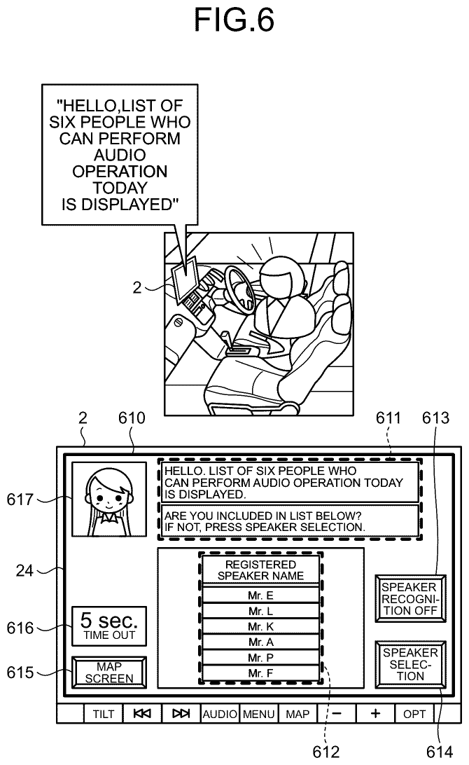

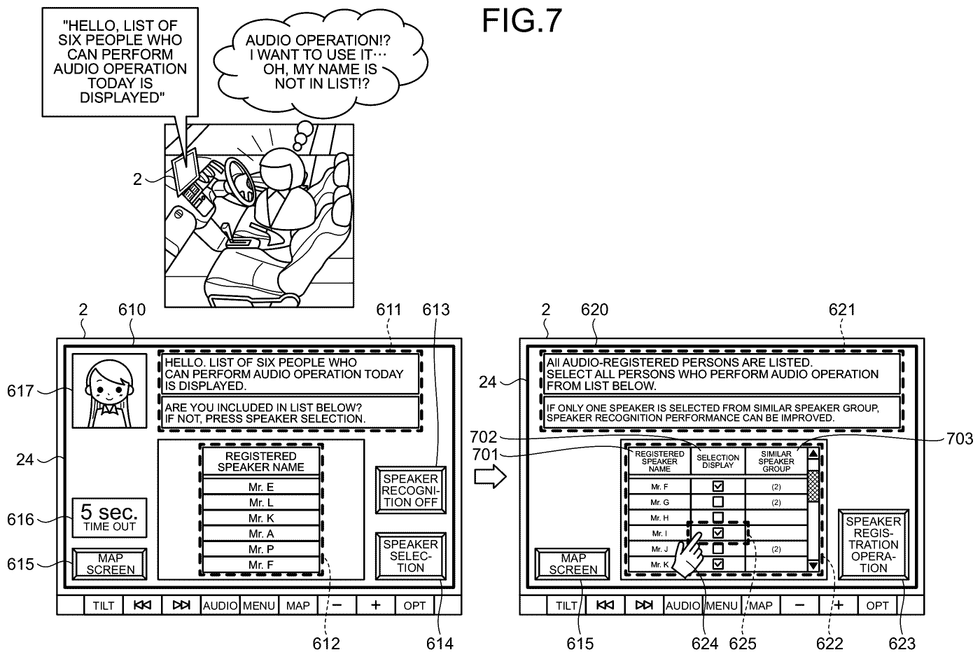

Next, an output example of six recognition target persons by the user presentation module 204 will be described in detail with reference to FIGS. 6 and 7.

FIG. 6 is a diagram illustrating an output example of the recognition target person. FIG. 6 illustrates an example of a case of presenting information in the in-vehicle device 2. As illustrated in FIG. 6, the in-vehicle device 2 provides audio guidance through the speaker 28. In addition, a list of six recognition target persons is output to the display 24 of the in-vehicle device 2, and a user operation is received.

The display 24 displays a user interface (UI) screen 610. The UI screen 610 is provided with an avatar display portion 617, a guidance information display portion 611, a list display portion 612, a speaker recognition OFF button 613, a speaker selection button 614, a timeout period display portion 616, and a map screen button 615.

The avatar display portion 617 performs a text-reading operation for prompting the user to browse the contents displayed on the guidance information display portion 611. The guidance information display portion 611 displays guidance such as the number of recognition target persons as text. The list display portion 612 list-displays a list of registered speaker names (registered speaker identification information) of the selected six recognition target persons. The list of registered speaker names of the six recognition target persons is an example of “recognition target person information”. The timeout period display portion 616 displays a timeout period for checking the list.

The speaker recognition OFF button 613, the speaker selection button 614, and the map screen button 615 are user operation buttons. The speaker recognition OFF button 613 is an operation button for switching ON and OFF of speaker recognition. The speaker selection button 614 is an operation button for switching to a speaker selection screen for manually correcting the selection of the recognition target person. The map screen button 615 is an operation button for switching to a map screen for navigation of the in-vehicle device 2.

The operation keys arranged at the bottom of the screen of the display 24 are operation keys dedicated to in-vehicle devices such as navigation.

FIG. 7 is a diagram illustrating an operation example of manually correcting selection of a recognition target person. By touching the speaker selection button 614 on the UI screen 610, the UI screen is switched to a UI screen 620 for correction as indicated by an arrow in FIG. 7.

The UI screen 620 for correction is provided with a correction guidance information display portion 621, a list display portion 622 for correction, a speaker registration operation button 623, and a map screen button 615.

The correction guidance information display portion 621 displays a guidance for correction by text. The list display portion 622 for correction acquires a list of all registered speakers, and displays the list so that each registered speaker can select addition, deletion, or the like. The speaker registration operation button 623 is an operation button for instructing a change to the speaker registration mode. The audio information of the new user is registered or the audio information of the user is added using the speaker registration operation button 623.

Here, the list display portion 622 for correction will be described in detail with a specific example. In the list display portion 622 for correction, as an example, as illustrated in FIG. 7, a selection display field 702 and a similar speaker G (similar speaker group) field 703 are displayed in a registered speaker name field 701 in association with each other, and scroll display can be performed so that the entire registered speakers can be corrected.

The registered speaker name field 701 list-displays the registered speakers. The selection display field 702 is a field for directly operating selection or cancellation of selection of the registered speaker. In this example, a check box is provided to directly operate selection and cancellation of each registered speaker by the check box.

### Case 1

A case where Mr. I actually uses the automatic selection output result illustrated in the list display portion 612 of the UI screen 610 of FIG. 7 will be considered. In this case, Mr. I is not included in the automatically selected recognition target persons. Since Mr. I can confirm that Mr. I is not included from the list display portion 612 of the UI screen 610, Mr. I touches the speaker selection button 614 to switch to the UI screen 620 for correction. In the list display portion 622 for correction, Mr. I places a cursor 624 on a check box 625 corresponding to Mr. I by the touch operation or the like, and turns on the check box 625. That Mr. I has been added to the recognition target person is notified from the user selection module 205 to the recognition target person selection module 206, and is added as the recognition target person. Furthermore, by addition, a person having the lowest value in the “utterance history coefficient” field 303 may be excluded from the recognition target person. When the UI screen 610 is returned, the list of registered speaker names in the list display portion 612 is updated. The correction in the list display portion 622 for correction can be repeatedly performed, and the correction can be performed even when the fellow passenger of the actual vehicle is not automatically selected.

### Case 2

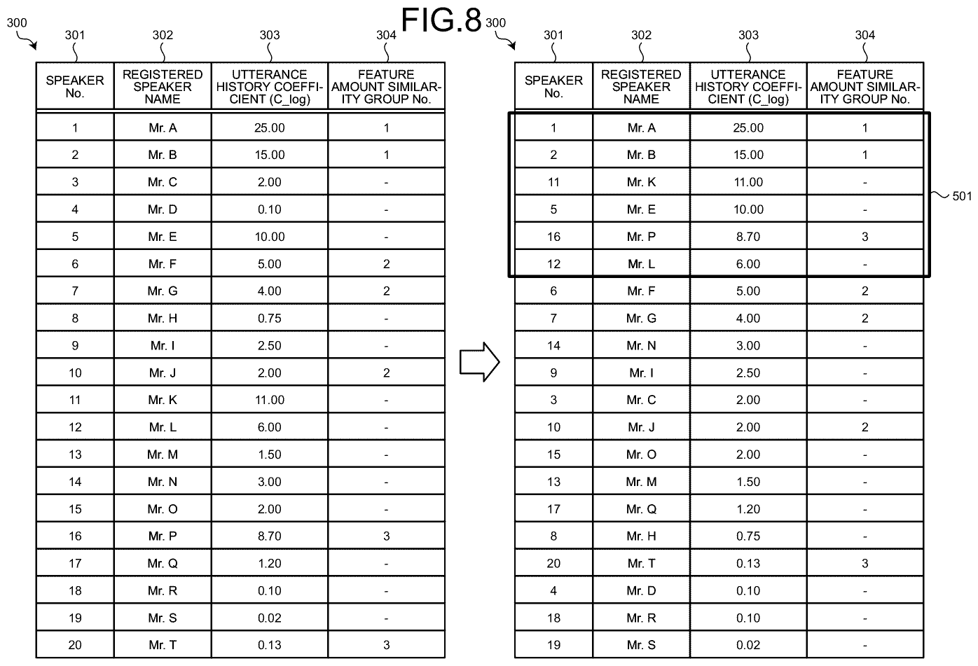

FIG. 8 is an explanatory diagram of Case 2 in which a plurality of members having the same group number are present among the selected recognition target persons. As illustrated in FIG. 8, when both the utterance history coefficients of Mr. A and Mr. B having the same group number in the registration information table 300 before sorting are high, Mr. A and Mr. B are included in the top two persons and the utterance history coefficient is the lower limit value “15” or more after sorting, and thus are included in the six recognition target persons 501.

Even in this case, it is possible to suppress false recognition by selecting an actual user from Mr. A and Mr. B and deleting the other.

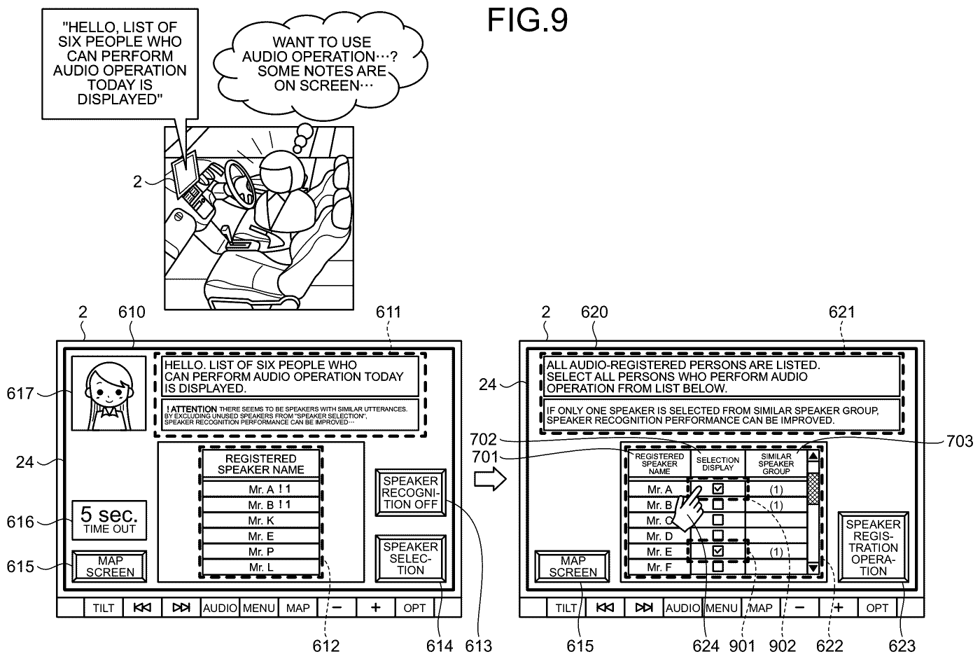

FIG. 9 is a diagram illustrating an output example of the UI screen 610 in Case 2 and an operation example of the UI screen 620 for correction. As illustrated in FIG. 9, the list of recognition target persons on the UI screen 610 includes a plurality of members having the same group number. Since there is a high possibility that members having the same group number are erroneously recognized, notification information for calling user's attention is included in the screen. In FIG. 9, as an example, contents for calling attention are displayed as texts on the guidance information display portion 611. In addition, in the list display portion 612, a symbol indicating a call attention to the side of the name of the member having the same group number, for example, “!” in red with the group number “1” of the similar speaker, and the like.

It is also possible to exclude one of Mr. A and Mr. B from the recognition target persons by unchecking one of the check boxes of Mr. A and Mr. B by the operation on the UI screen 620 for correction.

Note that, when there is only one member of the similar speaker group by an operation on the UI screen 620 for correction, the notation (text or symbol) of the call attention may disappear.

### Selection Flow of Recognition Target Person

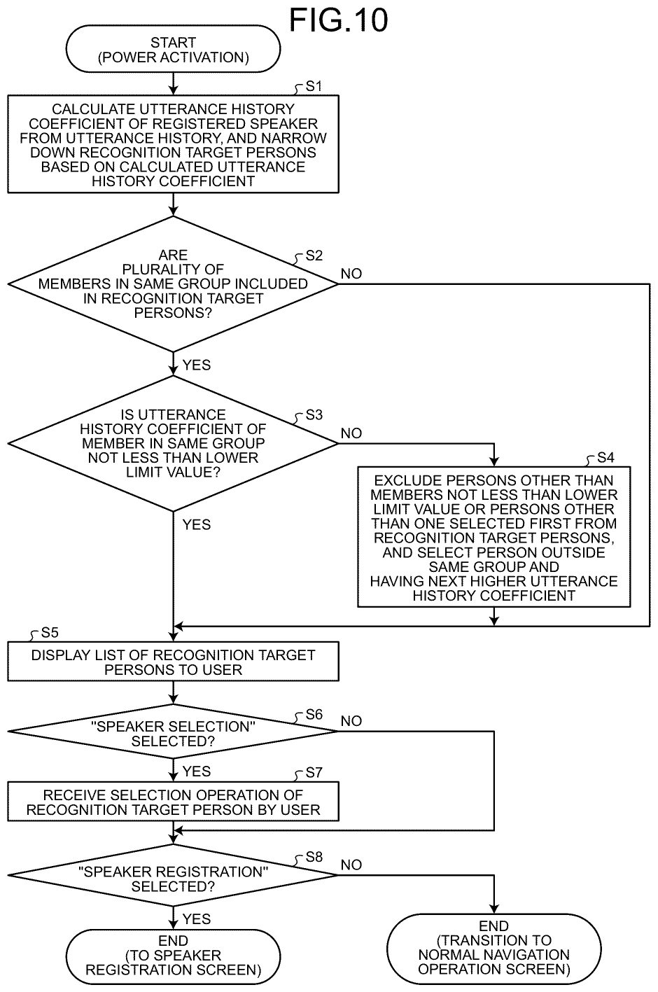

FIG. 10 is a diagram illustrating an example of a recognition target person selection flow. This selection flow is performed as preprocessing of a voice recognition mode immediately after power activation of the audio processing device.

First, the audio processing device calculates an utterance history coefficient of the registered speaker from the utterance history, and narrows down the recognition target persons based on the calculated utterance history coefficient (Step S1). The narrowing down of the recognition target persons is narrowed down such that the number of recognition target persons becomes a predetermined number (the number of settings and the like) in order from the registered speaker having the higher utterance history coefficient.

Subsequently, the audio processing device determines whether a plurality of members in the same group are included in the narrowed recognition target persons (Step S2).

In Step S2, in a case where a plurality of members in the same group are not included in the narrowed recognition target persons (Step S2: No), the audio processing device proceeds to Step S5.

On the other hand, in Step S2, in a case where a plurality of members in the same group are included in the narrowed recognition target persons (Step S2: Yes), the audio processing device determines whether the utterance history coefficients of the members in the same group are the lower limit value or more (Step S3).

Subsequently, in Step S3, in a case where there is a member whose utterance history coefficient is lower than the lower limit value among the members in the same group among the narrowed recognition target persons (Step S3: No), the audio processing device excludes, from the recognition target persons, a member other than the member whose utterance history coefficient is equal to or higher than the lower limit value or other than the first selected member, selects a person who is out of the same group and has the second highest utterance history coefficient (Step S4), and proceeds to Step S5.

On the other hand, in Step S3, in a case where each utterance history coefficient of the members in the same group is equal to or greater than the lower limit value (Step S3: Yes), the audio processing device list-displays a list of recognition target persons to the user (Step S5).

Subsequently, the audio processing device determines whether “speaker selection” (speaker selection button 614) has been selected (Step S6).

In Step S6, when “speaker selection” is not selected (Step S6: No), the audio processing device proceeds to Step S8.

On the other hand, in Step S6, when “speaker selection” is selected (Step S6: Yes), the audio processing device receives a selection operation of a recognition target person by the user (Step S7). The selection operation of the recognition target person by the user corresponds to an addition or deletion operation by the UI screen 620 for correction. When the addition or deletion operation is performed, the audio processing device adds or deletes the recognition target person.

Subsequently, the audio processing device determines whether “speaker registration” (the speaker registration operation button 623) has been selected (Step S8).

In Step S8, when “speaker registration” is not selected (Step S8: No), the audio processing device starts speaker recognition for the recognition target person selected in the processing of Steps S1 to S7 by transitioning to a normal navigation operation screen or the like.

On the other hand, in Step S8, when “speaker registration” is selected (Step S8: Yes), the audio processing device switches to the speaker registration mode, and receives the speaker registration on the speaker registration screen. After speaker registration, the audio processing device switches to the speaker recognition mode, and performs selection (processing included in Steps S1 to S7) of a speaker recognition target and speaker recognition.

### Modification 1

In the present embodiment, as a case where a plurality of members of the same similar speaker group are included in the recognition target persons, a case where both Mr. A and Mr. B who are members of group number 1 have a high utterance history coefficient and exceed the lower limit value has been described as an example (see FIG. 8). In the case of one example, it has been described that the recognition target person is determined while including both Mr. A and Mr. B or one of them is excluded by the determination of the user.

Then, as a modification of the embodiment, as a condition for the recognition target person selection module 206 to automatically select a recognition target person, a condition for automatically excluding a person having a lower utterance history coefficient when there is a difference of a predetermined value or more among the utterance history coefficients, may be added. In a case where this condition is added, if the difference between the utterance history coefficients of Mr. A and Mr. B is a predetermined value or more, the recognition target person selection module 206 can exclude in advance the person having a lower utterance history coefficient. In this case, it is not necessary to perform the user operation of excluding the person having a lower utterance history coefficient after the presentation of the recognition target person.

### Modification 2

Furthermore, in the embodiment, it has been described that the number of persons to be recognized can be narrowed down using the sensor. As an example, it has been described that since the vehicle includes the seat belt wearing sensor or the seat sensor, the number of passengers can be detected by combining the sensor outputs. In addition, it is also possible to detect the number of persons with an image sensor such as a camera.

In this manner, by combining the sensor detection to narrow down the number of persons to be recognized, it is possible to detect as one person if there is only one actual passenger. In this case, regardless of the condition of the lower limit value or the additional condition provided in Modification 1, it is possible to automatically narrow down the recognition target person to Mr. A who is the speaker having the highest utterance history coefficient, and to automatically exclude Mr. B.

### Modification 3

In Calculation Formula 1 for calculating the utterance history coefficient described in the embodiment, the weight of each intermediate parameter may be changed together with the use. For example, in the initial use stage, the calculation result of the utterance frequency of the users used on the same day of the week or in the same time zone is low in reliability because the number of times of audio operation is small, but the matching frequency of the users used on the same day of the week or in the same time zone gradually increases as the audio operation is used, and the reliability becomes high. Therefore, a weighting coefficient Awd of W_day(k) calculated based on the same day of the week or in the same time zone may be gradually increased together with the use.

### Modification 4

In the embodiment, the registered speaker DB 208 in which the audio processing device registers may be provided in an external storage such as a cloud. Furthermore, the utterance history coefficient calculation module 211 may set the speaker history by acquiring some or all pieces of information collected in an external storage.

As described above, the audio processing device according to the present embodiment or the modification performs processing of limiting the number of recognition target persons who perform speaker recognition to a predetermined number from among the registered speakers registered in the registration information. The recognition target person is determined based on an utterance history coefficient calculated from an utterance history of each speaker registration person and information of a similar speaker group calculated from registered audio information. For this reason, the recognition target person having a higher possibility of use is preferentially selected, and it is found that registered speakers of the similar speaker group are included, so that it is possible to reduce false recognition, and it is possible to improve usability of the user.

In addition, even in a case where registered speakers of the similar speaker group are included in the recognition target persons selected by the audio processing device, or an actual user is not included, the recognition target person selected by the audio processing device is presented to the user, so that the recognition target person can be corrected by the user's operation.

By reflecting this correction in the utterance history, the accuracy of the utterance history coefficient calculated by the audio processing device on the basis of the utterance history increases, and the accuracy of the selection of the recognition target person by the audio processing device increases as the audio processing device continues to be used repeatedly.

The present disclosure can be implemented by software, hardware, or software in cooperation with hardware.

Note that the present disclosure may be implemented by a system, an apparatus, a method, an integrated circuit, a computer program, or a recording medium, or may be implemented by any combination of a system, an apparatus, a method, an integrated circuit, a computer program, and a recording medium. The program product is a computer-readable medium on which a computer program is recorded.

In addition, a program in which some procedures or all procedures are recorded can be provided by being recorded in a recording medium, stored in a ROM and provided as a computer-configured information processing apparatus, or the program can be downloaded via a network and executed by a computer. The CPU of the computer reads and executes the program to perform processing.

According to the present disclosure, it is possible to reduce false recognition of voice recognition in a case where pieces of audio information of a plurality of registered users are similar to each other.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### (Supplement)

Aspects of the present disclosure are, for example, as follows.

### (Item 1)

An audio processing device includes:
a memory in which a program is stored; and
a processor coupled to the memory and configured to perform processing by executing the program, the processing including:
   calculating, from registration information in which pieces of audio information of a plurality of users are registered, group information for each user group in which features of the pieces of the audio information are similar between the users;
   calculating utterance history coefficients for the users based on utterance histories of the users;
   selecting a predetermined number of users from among the users as recognition targets of the pieces of the audio information based on the utterance history coefficients;
   outputting recognition target person information of the selected recognition targets; and
   outputting the recognition target person information and information indicating that a plurality of users having a same user group are included when the plurality of users having the same user group are included in the selected recognition targets.

### (Item 2)

In the audio processing device according to Item 1, the processing includes calculating a value of the utterance history coefficient to be higher for a user corresponding to a piece of the audio information having a larger number of times of recognition as an utterance in past, among the registered pieces of the audio information of the users.

### (Item 3)

In the audio processing device according to Item 1 or 2, the processing includes calculating a value of the utterance history coefficient to be higher for a piece of the audio information having a larger number of times of recognition as an utterance in a predetermined period in past, among the registered pieces of the audio information of the users.

### (Item 4)

In the audio processing device according to any one of Items 1 to 3, the processing includes calculating a value of the utterance history coefficient to be higher for a user corresponding to a piece of the audio information in which a day of a week or a time zone having a larger number of times of recognition of an utterance in past is closer to a current day of a week or a current time zone, among the registered pieces of the audio information of the users.

### (Item 5)

In the audio processing device according to any one of Items 1 to 4, the processing includes deleting, from the recognition targets, when the plurality of users having the same user group are included in the recognition targets to be selected, a user whose utterance history coefficient satisfies a predetermined condition among the plurality of users having the same user group, based on the utterance history coefficients of the plurality of users having the same user group.

### (Item 6)

In the audio processing device according to any one of Items 1 to 5, the processing further includes receiving, from a user of the users, selection of addition or deletion of a recognition target person to or from the recognition target person information.

### (Item 7)

In the audio processing device according to any one of Items 1 to 6, the processing further includes:
inputting a voice of a speaker; and
recognizing the speaker of the input voice based on the pieces of the audio information respectively corresponding to recognition target persons of the recognition targets.

### (Item 8)

The audio processing device according to any one of Items 1 to 6, wherein the processing further includes:
inputting a voice of a speaker;
recognizing the speaker of the input voice based on the pieces of audio information respectively corresponding to recognition target persons of the recognition targets; and
calculating the audio information based on an audio signal of the voice of the speaker and registering the audio information in the registration information.

### (Item 9)

An audio processing method includes:
calculating, from registration information in which pieces of audio information of a plurality of users are registered, group information for each user group in which features of the pieces of the audio information are similar between users;
calculating utterance history coefficients for the users based on utterance histories of the users;
selecting a predetermined number of users from among the users as recognition targets of the pieces of the audio information based on the utterance history coefficients;
outputting recognition target person information of the selected recognition targets; and
outputting the recognition target person information and information indicating that a plurality of users having a same user group are included when the plurality of users having the same user group are included in the selected recognition targets.

### (Item 10)

A non-transitory computer readable medium in and on which programmed instructions are embodied and stored, wherein the instructions, when executed by a computer, cause the computer to perform:
calculating, from registration information in which pieces of audio information of a plurality of users are registered, group information for each user group in which features of the pieces of the audio information are similar between the users;
calculating utterance history coefficients for the users based on utterance histories of the users;
selecting a predetermined number of users from among the users as recognition targets of the pieces of the audio information based on the utterance history coefficients;
outputting recognition target person information of the selected recognition targets; and
outputting the recognition target person information and information indicating that a plurality of users having a same user group are included when the plurality of users having the same user group are included in the selected recognition targets.

What is claimed is:

1. An audio processing device comprising:
a memory in which a program is stored; and
a processor coupled to the memory and configured to perform processing by executing the program, the processing including:
calculating, from registration information in which pieces of audio information of a plurality of users are registered, group information for each user group in which features of the pieces of the audio information are similar between the users;
calculating utterance history coefficients for the users based on utterance histories of the users;
selecting a predetermined number of users from among the users as recognition targets of the pieces of the audio information based on the utterance history coefficients;
outputting recognition target person information of the selected recognition targets; and
outputting the recognition target person information and information indicating that a plurality of users having a same user group are included when the plurality of users having the same user group are included in the selected recognition targets.

2. The audio processing device according to claim 1, wherein the processing includes calculating a value of the utterance history coefficient to be higher for a user corresponding to a piece of the audio information having a larger number of times of recognition as an utterance in past, among the registered pieces of the audio information of the users.

3. The audio processing device according to claim 1, wherein the processing includes calculating a value of the utterance history coefficient to be higher for a piece of the audio information having a larger number of times of recognition as an utterance in a predetermined period in past, among the registered pieces of the audio information of the users.

4. The audio processing device according to claim 1, wherein the processing includes calculating a value of the utterance history coefficient to be higher for a user corresponding to a piece of the audio information in which a day of a week or a time zone having a larger number of times of recognition of an utterance in past is closer to a current day of a week or a current time zone, among the registered pieces of the audio information of the users.

5. The audio processing device according to claim 1, wherein the processing includes deleting, from the recognition targets, when the plurality of users having the same user group are included in the recognition targets to be selected, a user whose utterance history coefficient satisfies a predetermined condition among the plurality of users having the same user group, based on the utterance history coefficients of the plurality of users having the same user group.

6. The audio processing device according to claim 2, wherein the processing includes deleting, from the recognition targets, when the plurality of users having the same user group are included in the recognition targets to be selected, a user whose utterance history coefficient satisfies a predetermined condition among the plurality of users having the same user group, based on the utterance history coefficients of the plurality of users having the same user group.

7. The audio processing device according to claim 3, wherein the processing includes deleting, from the recognition targets, when the plurality of users having the same user group are included in the recognition targets to be selected, a user whose utterance history coefficient satisfies a predetermined condition among the plurality of users having the same user group, based on the utterance history coefficients of the plurality of users having the same user group.

8. The audio processing device according to claim 4, wherein the processing includes deleting, from the recognition targets, when the plurality of users having the same user group are included in the recognition targets to be selected, a user whose utterance history coefficient satisfies a predetermined condition among the plurality of users having the same user group, based on the utterance history coefficients of the plurality of users having the same user group.

9. The audio processing device according to claim 1, wherein the processing further includes receiving, from a user of the users, selection of addition or deletion of a recognition target person to or from the recognition target person information.

10. The audio processing device according to claim 2, wherein the processing further includes receiving, from a user of the users, selection of addition or deletion of a recognition target person to or from the recognition target person information.

11. The audio processing device according to claim 3, wherein the processing further includes receiving, from a user of the users, selection of addition or deletion of a recognition target person to or from the recognition target person information.

12. The audio processing device according to claim 4, wherein the processing further includes receiving, from a user of the users, selection of addition or deletion of a recognition target person to or from the recognition target person information.

13. The audio processing device according to claim 1, wherein
the processing further includes:
inputting a voice of a speaker; and
recognizing the speaker of the input voice based on the pieces of the audio information respectively corresponding to recognition target persons of the recognition targets.

14. The audio processing device according to claim 2, wherein
the processing further includes:
inputting a voice of a speaker; and
recognizing the speaker of the input voice based on the pieces of the audio information respectively corresponding to recognition target persons of the recognition targets.

15. The audio processing device according to claim 3, wherein
the processing further includes:
inputting a voice of a speaker; and
recognizing the speaker of the input voice based on the pieces of the audio information respectively corresponding to recognition target persons of the recognition targets.

16. The audio processing device according to claim 4, wherein
the processing further includes:
inputting a voice of a speaker; and
recognizing the speaker of the input voice based on the pieces of the audio information respectively corresponding to recognition target persons of the recognition targets.

17. The audio processing device according to claim 13, wherein the processing further includes calculating the audio information based on an audio signal of the voice of the speaker and registering the audio information in the registration information.

18. An audio processing method comprising:
calculating, from registration information in which pieces of audio information of a plurality of users are registered, group information for each user group in which features of the pieces of the audio information are similar between users;
calculating utterance history coefficients for the users based on utterance histories of the users;
selecting a predetermined number of users from among the users as recognition targets of the pieces of the audio information based on the utterance history coefficients;
outputting recognition target person information of the selected recognition targets; and
outputting the recognition target person information and information indicating that a plurality of users having a same user group are included when the plurality of users having the same user group are included in the selected recognition targets.

19. A non-transitory computer readable medium in and on which programmed instructions are embodied and stored, wherein the instructions, when executed by a computer, cause the computer to perform:
calculating, from registration information in which pieces of audio information of a plurality of users are registered, group information for each user group in which features of the pieces of the audio information are similar between the users;
calculating utterance history coefficients for the users based on utterance histories of the users;
selecting a predetermined number of users from among the users as recognition targets of the pieces of the audio information based on the utterance history coefficients;
outputting recognition target person information of the selected recognition targets; and
outputting the recognition target person information and information indicating that a plurality of users having a same user group are included when the plurality of users having the same user group are included in the selected recognition targets.
